(19) United States
(12) Patent Application Publication
(10) Pub. No.: US 2022/0316074 A1
(43) Pub. Date: Oct. 6, 2022

(54) METHOD AND DEVICE FOR ELECTROCHEMICAL HYDROGEN COMPRESSION

(71) Applicant: Robert Bosch GmbH, Stuttgart (DE)

(72) Inventors: Andreas Gehrold, Bamberg (DE); Dietmar Steiner, Welzheim (DE); Stefan Martin, Filderstadt (DE)

(21) Appl. No.: 17/754,046

(22) PCT Filed: Oct. 7, 2020
(86) PCT No.: PCT/EP2020/078106

§ 371 Date: Mar. 22, 2022

(30) Foreign Application Priority Data
Oct. 16, 2019 (DE) 10 2019 215 891.9

(51) Int. Cl. C25B 1/02; C25B 15/08; C25B 9/19; B01D 53/32; B01D 53/26

(52) U.S. Cl. CPC C25B 1/02; C25B 15/087; C25B 15/083; C25B 9/19; B01D 53/326; B01D 53/26

(57) ABSTRACT

A method for electrochemical hydrogen compression. The method includes: providing hydrogen gas having a relative humidity RH of 100%; providing inert gas having a relative humidity RH of 100%; mixing the humidified hydrogen gas and the humidified inert gas; electrochemically oxidizing the hydrogen gas at an anode; transporting the protons obtained as a result of the oxidation and at least a portion of the humidified inert gas through a membrane; and electrochemically reducing the protons at a cathode into hydrogen.

### FIELD

The present invention relates to a method and to a device for electrochemical hydrogen compression.

### BACKGROUND INFORMATION

A method for the electrochemical compression of hydrogen is described, e.g., in PCT Patent Application No. WO 03/021006 A1, by which hydrogen is generated at such a high pressure that the pressure is sufficient to fill a hydrogen tank. During the electrochemical compression, hydrogen gas is oxidized at an anode. The arising protons pass through a membrane and are reduced at a cathode back to molecular hydrogen. The driving force is the applied current intensity (voltage). In other words, the electrons drive the hydrogen from the low pressure side (anode) to the high pressure side (cathode), the hydrogen flow being proportional to the applied current intensity. To obtain the proton conductivity of the membrane, the membrane must be humidified. The protons passing through the membrane, however, carry water molecules through the membrane, which is referred to as electroosmotic drag, so that the membrane is depleted of moisture. To prevent the membrane from drying out, however, it is not sufficient to set the relative humidity of the hydrogen gas on the anode side to 100%. An oversaturation of the hydrogen gas with water vapor is also not possible in all areas of the membrane.

### SUMMARY

The present invention may solve the problem, and provides a method for the electrochemical compression of hydrogen in which the membrane is permanently humidified with sufficient water vapor.

In accordance with an example embodiment of the present invention, the method initially includes a step of providing hydrogen gas having a relative humidity RH of 100%, as well as providing inert gas having a relative humidity RH of 100%. The relative humidity shall be understood to mean the saturation of the gases with water vapor. The relative humidity may be determined according to the Magnus formula for a certain pressure and a certain temperature. For example, according to the Magnus formula, the following values result for the inert gas system (nitrogen or helium)/water:

N₂/H₂O at 60° C. and an anode pressure of 30 bar: approximately 4 g H₂O/kg N₂.

He/H₂O at 60° C. and an anode pressure of 30 bar: approximately 30 g H₂O/kg N₂.

The hydrogen gas may be provided from an arbitrary process, which is provided upstream from the electrochemical compression, such as, for example, from an upstream electrolysis, from chemical processes, such as, e.g., steam cracking, or also only from a hydrogen tank. The hydrogen gas is then humidified with water vapor to obtain a relative humidity RH of the hydrogen gas, for example in a humidifier.

The inert gas is also humidified, it being possible to use any arbitrary inert gas or any arbitrary mixture of two or more inert gases and, in particular nitrogen, as inert gas.

In a subsequent step, the mixing of the humidified hydrogen gas and of the humidified inert gas takes place. Not only is the hydrogen gas diluted in this way, additionally moisture from the unreactive inert gas also finds its way to the membrane and, in particular also onto and into the anode side of the membrane, so that an additional humidification of the membrane takes place. With this, the membrane is effectively prevented from drying out during the electrochemical compression of hydrogen.

As a result, an electrochemical oxidation of the hydrogen gas at an anode, a transporting of the protons obtained as a result of the oxidation and, possibly, of at least a portion of the humidified inert gas through a membrane, and an electrochemical reduction of the protons at a cathode into hydrogen take place, without the membrane being considerably depleted of moisture, namely through the inert gas carrying water vapor, and thus moisture, which brings the moisture to or into the anode, and thus also to the membrane. In this way, a high concentration of moisture is thus present at the anode side of the membrane at all times, so that the membrane never dries out, and is thus always able to conduct protons well, even when the membrane-penetrating protons carry water vapor through the membrane. The method is simple, implementable without high technical complexity, and enables a permanently good electrochemical compression of hydrogen with high efficiency.

Advantageous refinements and embodiments of the present invention are disclosed herein.

According to one advantageous refinement of the present invention, the mixing of humidified hydrogen gas and humidified inert gas takes place at a mixing ratio of 99:1 to 1:99, based on the volume. The higher the proportion of humidified inert gas, the higher is also the humidification rate of the membrane, thereby allowing a permanently good proton conductivity, and thus a high efficiency of the method, to be achieved. A mixing ratio of 10:90 to 40:60, based on the volume, is thus particularly advantageous, and, in particular, a mixing ratio of 20:80, based on the volume.

To further enhance the efficiency of the method, it advantageously includes a step of setting the hydrogen gas pressure and/or the inert gas pressure to a target pressure of 1 to 50 bar, preferably to 25 to 40 bar. This refers to the pressure that is set for the corresponding gas before the humidified hydrogen gas is mixed with the humidified inert gas.

In light of a cost reduction for the method, it is furthermore advantageously provided that the inert gas, after having been transported to the anode, is recycled and made available again, after a humidification to a relative humidity RH of 100%, for mixing with further hydrogen gas, which was brought to a relative humidity RH of 100%. This means that the inert gas is possibly separated and, in particular, transported back to the anode side through a recycling line. There, it may either be stored or be reused immediately by being humidified again and mixed with humidified hydrogen gas.

Moreover advantageously, water is additionally separated from the hydrogen generated at the cathode. In this way, the hydrogen may also be obtained in highly pure form.

In accordance with an example embodiment of the present invention, in addition, water may be separated, for example via a water separator, from the hydrogen present at the cathode and/or from the inert gas present at the cathode, and may be recycled. The recycling means that the separated water is used again to humidify hydrogen gas and/or inert gas and, for this purpose is supplied, e.g., via a recycling line, to the anode side and, in particular, to a humidifier for hydrogen gas and/or inert gas.

To simplify the transport of the inert gas, in particular through the membrane, the mechanical energy required for transporting the humidified inert gas is preferably provided by the hydrogen generated at the cathode.

The provision of the energy may, in particular, advantageously take place in that the method includes a step of expanding the hydrogen generated at the cathode, in particular, at an expansion turbine. Through the expansion of the hydrogen, mechanical energy may be generated, for example through the operation of the expansion turbine, which may be used for transporting the inert gas.

Also according to an example embodiment of the present invention, a device for the electrochemical hydrogen compression is also described. The device is designed in such a way that it is able to carry out the above method according to the present invention for the electrochemical hydrogen compression.

In accordance with an example embodiment, the device according to the present invention includes:
an anode for the electrochemical oxidation of hydrogen gas;
a membrane for transporting the protons obtained as a result of the oxidation;
a cathode for the electrochemical reduction of the protons into hydrogen;
a first humidifier for humidifying the hydrogen gas to be supplied to the anode to a relative humidity RH of 100%;
a first hydrogen supply unit for supplying hydrogen to the first humidifier;
a second humidifier for humidifying the insert gas to be supplied to the anode to a relative humidity RH of 100%;
a first inert gas supply unit for supplying inert gas to the second humidifier;
a mixing device for mixing the humidified inert gas and the humidified hydrogen gas;
a second hydrogen supply unit for supplying the humidified hydrogen gas to the mixing device;
a second inert gas supply unit for supplying the humidified inert gas to the mixing device; and
a mixing gas supply unit for supplying the mixture of the humidified hydrogen gas and the humidified inert gas to the anode.

The anode, the membrane, and the cathode are also referred to as an electrochemical hydrogen compression (EHC) unit. In the process, the anode is situated on the low pressure side, and the cathode is situated on the high pressure side. The proton-conducting membrane is situated between the anode and the cathode.

The first and second humidifiers are designed in such a way that they accordingly apply water vapor to the hydrogen gas and the inert gas, so that the relative humidity RH of the hydrogen gas and of the inert gas attains 100%.

The mixing device may, for example, include a throttle valve or a mixing valve. In this way, it is very easy to set a desired mixing ratio, based on the volume, of humidified hydrogen gas to humidified inert gas, which is preferably from 10:90% to 40:60%, and, in particular, is 20:80%.

The device according to the present invention has a permanently high efficiency, which results from the membrane being very well humidified at all times due to the admixing of humidified inert gas having a relative humidity RH of 100% to hydrogen gas having a relative humidity RH of 100%.

The advantages, advantageous effects and refinements set out for the method according to the present invention are also applied to the device according to the present invention. With respect to the statements regarding the device according to the present invention, reference is thus additionally also made to the method according to the present invention.

Advantageously, in accordance with an example embodiment of the present invention, the device furthermore includes at least one compression device and/or throttle and/or pump for setting the hydrogen gas pressure and/or the inert gas pressure to a target pressure of 1 bar to 50 bar, so that a particularly high efficiency may be achieved.

In accordance with an example embodiment of the present invention, to further enhance the efficiency of the device, the device furthermore advantageously includes a water separator for separating water from the hydrogen generated at the cathode. In this way, high purity hydrogen may be obtained on the one hand, and water may be recycled on the other hand.

To recycle the water particularly efficiently, the device moreover advantageously includes a water recycling line for transporting water from the cathode into the first humidifier and/or into the second humidifier. Moreover, an anode waste gas line may also be provided, which discharges inert gas that has not passed through the membrane and, for example, supplies it to the second humidifier.

Moreover advantageously the device includes an expansion device for generating mechanical energy for transporting the humidified inert gas. The expansion device may particularly advantageously be designed as an expansion turbine, which converts expansion energy into mechanical energy with high efficiency.

### DETAILED DESCRIPTION OF EXAMPLE EMBODIMENTS

Exemplary embodiments of the present invention are described hereafter in detail with reference to the figures.

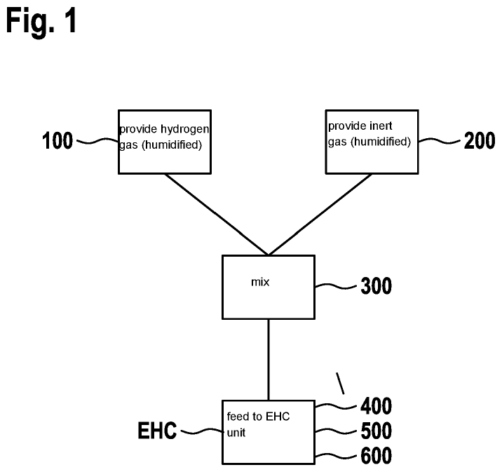

FIG. 1 shows a method diagram, illustrating method steps of a method for the electrochemical hydrogen compression according to a first specific embodiment of the present invention.

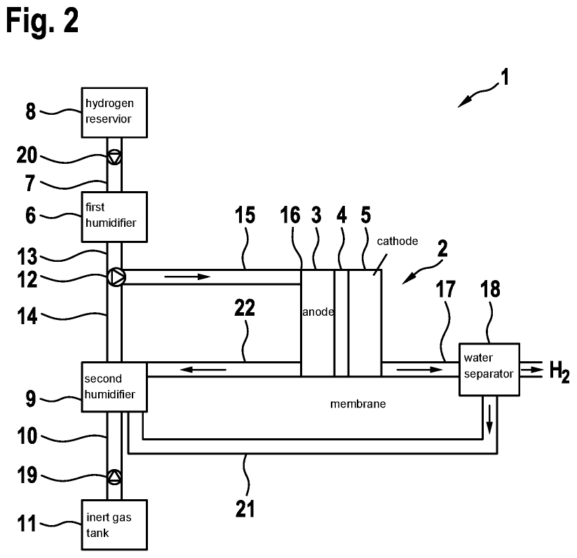

FIG. 2 shows a schematic view of a device for the electrochemical hydrogen compression according to a second specific embodiment of the present invention.

### DETAILED DESCRIPTION OF EXAMPLE EMBODIMENTS

The figures only represent certain main features of the present invention. Remaining possible features have been omitted for the sake of clarity. Furthermore, identical reference numerals denote identical components.

As is shown FIG. 1, in accordance with an example embodiment of the present invention, the method includes six method steps.

In a first method step 100, hydrogen gas having a relative humidity RH of 100% is provided. The hydrogen gas may, e.g., stem from a hydrogen tank or also from a hydrogen-generating reaction system, such as, e.g., an electrolysis device. The hydrogen gas is then, for example, brought to a relative humidity of 100% in a humidifier using water vapor.

In a second method step 200, which may also run in parallel to first method step 100, inert gas having a relative humidity RH of 100% is provided. Any inert gas and also mixtures of two or more inert gases are possible. Particularly preferably, nitrogen is used as the inert gas. The inert gas may also be humidified in a humidifier.

In a third method step 300, a mixing of the humidified hydrogen gas and of the humidified inert gas takes place. For this purpose, the humidified hydrogen gas and the humidified inert gas are fed to a mixing device, which in the simplest case encompasses a throttle valve or a mixing valve.

The mixed gas made up of humidified hydrogen gas and humidified inert gas is then fed to an EHC unit, in which the following method steps are carried out:
400: electrochemical oxidation of the hydrogen gas at an anode;
500: transporting the protons obtained as a result of the oxidation through a proton-conductive membrane; and
600: electrochemical reduction of the protons at a cathode into hydrogen.

By mixing humidified hydrogen gas having a relative humidity RH of 100% and humidified inert gas having a relative humidity RH of 100%, the membrane of the EHC unit is kept permanently moist, so that the method is also characterized by a permanently high and efficient executability.

FIG. 2 shows a device 1 for the electrochemical compression of hydrogen according to a second specific embodiment. Device 1 is suitable for carrying out the method illustrated in FIG. 1.

Device 1 includes an EHC unit 2, which includes an anode 3 for the electrochemical oxidation of hydrogen gas, a membrane 4 for transporting the protons obtained as a result of the oxidation, and a cathode 5 for the electrochemical reduction of the protons into hydrogen. The EHC unit is connected to a voltage source (not shown), a driving force for the passage of the protons through the membrane being generated by the obtained current intensity. The higher the current intensity, the more protons pass through the membrane, and the more hydrogen is generated at the cathode.

Device 1 furthermore includes a first humidifier 6 for humidifying the hydrogen gas to be supplied to anode 3 to a relative humidity RH of 100%. A first hydrogen supply unit 7 is provided in the process to supply hydrogen, for example from a hydrogen reservoir 8, which is, e.g., a hydrogen tank, to first humidifier 6.

Moreover, a second humidifier 9 for humidifying the insert gas to be supplied to anode 3 to a relative humidity RH of 100% is provided. A first inert gas supply unit 10 supplies the inert gas to second humidifier 9, e.g., from an inert gas tank 11.

Device 1 furthermore includes a mixing device 12 which, e.g., encompasses a throttle valve or mixing valve, for mixing the humidified inert gas and the humidified hydrogen gas, a second water supply unit 13 for supplying the humidified hydrogen gas into mixing device 12 and a second inert gas supply unit 14 for supplying the humidified inert gas to mixing device 12 being provided.

The mixture of the humidified hydrogen gas and the humidified inert gas is then supplied via a mixed gas supply unit 15 to anode 3 via anode input 16.

The hydrogen generated at cathode 5 may still contain residual water. The hydrogen/water mixture obtained at the cathode may be discharged from cathode 5 via a cathode waste gas line 17 and, for example, be supplied to a water separator 18.

In water separator 18, the hydrogen/water mixture is separated into pure hydrogen and water, it being possible to supply the hydrogen, e.g., to a hydrogen storage system (not shown). The separated water may, e.g., be supplied to second humidifier 9 via a water recycling line 21. As an alternative or in addition, the separated water may also be supplied to first humidifier 6.

Inert gas which has not passed through membrane 4 may be supplied to second humidifier 9 again via an anode waste gas line 22, and may thus be recycled.

In first hydrogen supply unit 7 and in first inert gas supply unit 10, compression devices, such as, e.g., a respective pump 19, 20, may be provided, to set the hydrogen gas pressure and the inert gas pressure to a target pressure of 1 bar to 50 bar.

Furthermore, the device may include an expansion device (not shown), such as, e.g., an expansion turbine, for generating mechanical energy for transporting the humidified inert gas. The expansion device may be situated in cathode waste gas line 17, for example.

As a result of mixing humidified inert gas and humidified hydrogen gas in mixing device 12 and supplying the obtained mixed gas having a relative humidity RH of 100%, membrane 4 may be kept moist, in particular, on the anode side, so that EHC unit 2 shows a permanently high performance, and protons may pass through the membrane very well and may be reduced again at the cathode.

1-13. (canceled)

14. A method for electrochemical hydrogen compression, comprising the following steps:
providing hydrogen gas having a relative humidity RH of 100%;
providing inert gas having a relative humidity RH of 100%;
mixing the humidified hydrogen gas and the humidified inert gas;
electrochemically oxidizing the hydrogen gas at an anode;
transporting protons obtained as a result of the oxidation through the membrane; and
electrochemically reducing the protons at a cathode into hydrogen.

15. The method as recited in claim 14, wherein the mixing of humidified hydrogen gas and humidified inert gas takes place at a mixing ratio of 99:1 to 1:99, based on volume.

16. The method as recited in claim 15, wherein the mixing ratio is 10:90 to 40:60, based on the volume.

17. The method as recited in claim 14, further comprising:
setting a hydrogen gas pressure and/or a inert gas pressure to a target pressure of 1 bar to 50 bar.

18. The method as recited in claim 14, wherein the inert gas, after having been transported to the anode, is recycled and made available again, after a humidification to a relative humidity RH of 100%, for mixing with further hydrogen gas, which was brought to a relative humidity RH of 100%.

19. The method as recited in claim 14, further comprising:
separating water from the hydrogen obtained at the cathode.

20. The method as recited in claim 19, further comprising:
recycling the separated water and supplying the separated water to hydrogen gas and/or inert gas to be humidified.

21. The method as recited in claim 14, wherein the mechanical energy for transporting the humidified inert gas is provided by the hydrogen generated at the cathode.

22. The method as recited in claim 21, further comprising:
expanding the hydrogen generated at the cathode at an expansion turbine.

23. A device for electrochemical hydrogen compression, comprising:
an anode configured for an electrochemical oxidation of hydrogen gas;
a membrane configured to transport protons obtained as a result of the oxidation;
a cathode configured for an electrochemical reduction of the protons into hydrogen;
a first humidifier configured to humidify the hydrogen gas to be supplied to the anode to a relative humidity of 100%;
a first hydrogen supply unit configured to supply hydrogen to the first humidifier;
a second humidifier unit configured to humidify inert gas, to be supplied to the anode, to a relative humidity RH of 100%;
a first inert gas supply unit configured to supply the inert gas to the second humidifier;
a mixing device configured to mix the humidified inert gas and the humidified hydrogen gas;
a second hydrogen supply unit configured to supply the humidified hydrogen gas to the mixing device;
a second inert gas supply unit configured to supply the humidified inert gas to the mixing device; and
a mixing gas supply unit configured to supply the mixture of the humidified hydrogen gas and the humidified inert gas to the anode.

24. The device as recited in claim 23, further comprising:
at least one compression device and/or throttle and/or pump configured to set a pressure of the hydrogen gas and/or the inert gas to a target pressure of 1 bar to 50 bar.

25. The device as recited in claim 23, further comprising:
a water separator configured to separate water from the hydrogen generated at the cathode.

26. The device as recited in claim 23, further comprising:
a water recycling line configured to transport water from the cathode into the first humidifier and/or into the second humidifier.

27. The device as recited in claim 23, further comprising:
an expansion turbine configured to generate mechanical energy for transporting the humidified inert gas.
